(19) United States
(12) Patent Application Publication
(10) Pub. No.: US 2015/0380132 A1
(43) Pub. Date: Dec. 31, 2015

(54) MANUFACTURING PROCESS AND APPARATUS FOR CRIMPING AND/OR SWAGING STRAIN INSULATORS

(71) Applicant: AFL TELECOMMUNICATIONS LLC, Duncan, SC (US)

(72) Inventors: David Eric PARSONS, Simpsonville, SC (US); James David LOGAN, Greer, SC (US)

(73) Assignee: AFL TELECOMMUNICATIONS LLC, Duncan, SC (US)

(21) Appl. No.: 14/768,975

(22) PCT Filed: Feb. 20, 2014
(86) PCT No.: PCT/US14/17357

§ 371 Date: Aug. 19, 2015

Related U.S. Application Data
(60) Provisional application No. 61/767,024, filed on Feb. 20, 2013.

(51) Int. Cl. H01B 19/00

(52) U.S. Cl. CPC H01B 19/00

(57) ABSTRACT

Methods for manufacturing strain insulators are disclosed. The methods may include swaging and/or crimping, by a die-set, a sleeve of an end fitting on a portion of a core strength rod, the portion being disposed inside the sleeve of the end fitting. The swaging may be performed by an upper block and a lower block of the die-set. At least one of the upper and lower blocks may be movable such as to allow for compressing the sleeve of the end fitting on the rod disposed between the blocks. The upper block may include a plurality of protrusions extending lengthwise on the upper block and the lower block may include a plurality of protrusions extended lengthwise on the lower block.

### CROSS REFERENCE TO RELATED APPLICATION

This application claims the benefit of U.S. Provisional Patent Application No. 61/767,0246, filed on Feb. 20, 2013, which is hereby incorporated by reference for all purposes as if fully set forth herein.

### BACKGROUND

1. Field

Exemplary embodiments of the present invention relate to a method and apparatus for manufacturing strain insulators

2. Discussion of the Background

Strain insulators are electrical insulators used in overhead electrical wiring for supporting overhead power lines and cables. Strain insulators are designed to provide electrical insulation and to withstand the strain or mechanical tension due to the pull of a suspended electrical wire or cable. A strain insulator may be used to attach an electrically active wire to a pole or a tower. In such a situation the strain insulator transmits the pull of the wire to the supporting pole or tower and at the same time electrically insulates the live wire from the supporting pole or tower. Further, a strain insulator may be used as insert between two lengths of wire to mechanically connect the two wires while electrically isolating them from each other. Strain insulators must have considerable mechanical strength in order to sustain the tensile loads of a conductor and the necessary electrical insulating properties to work at the desired voltage level.

FIG. 1 shows a typical strain insulator 10. A strain insulator may comprises a rod 1 and two end fittings 12. The rod 10 may be a fiber glass rod and may be formed to provide mechanical strength and good electrical insulating qualities. The end fittings may be made by various metallic and/or non-metallic materials. The end fittings may come in various forms 13 such as a clevis, clevis with roller, a Y clevis, a thimble eye, and others. The shape of the end fittings may be adapted and designed according to the specific application. The end fittings must be attached to the fiber glass rod such as to withstand the desired mechanical strain caused by the wire pull.

In the conventional methods for manufacturing strain insulators the end fittings are attached to the fiberglass rod by a swaging and crimping process. Specifically, as shown in FIGS. 2A and 2B a set of swaging and crimping forces F may be applied on the end-fittings and may compress the fittings against the fiberglass rod thereby attaching, by swaging and crimping, the end-fittings on the rod. The set of crimping and swaging forces F may be applied in pairs complementary to each other on the sleeves 14 surrounding the rod 11 as shown in FIG. 2A. FIG. 3A shows a conventional die-set 30 for swaging and crimping of the end-fittings one the fiberglass rod. The die-set 30 may include a plurality of swaging pressure blocks 1 to 8. The rod 11 and the end fitting 12 may be inserted in the die and the blocks 1 to 8 may be pushed against fitting sleeves 14 such as to swag and crimp the sleeve on the rod 11. The force applied by the blocks 31 must be sufficiently large such as to strongly attach the fittings on the rod and ensure that the attachment withstands the desired mechanical strain.

The above method of manufacturing strain insulators is used by almost every major manufacturer. However, the above described method and equipment has a couple of major drawbacks with respect to the manufacturing equipment investment, manufacturing production time efficiencies. Further, strain insulators manufactured by using the conventional method above have the drawback of a resulting mechanical stress point loading that reduces insulators' lifespan. Accordingly new tools and methods are needed to rectify the above mentioned drawbacks of the conventional apparatus and methods for swaging and crimping strain insulators.

The above information disclosed in this background section is only for enhancement of understanding of the background of the invention and therefore it may contain information that does not form any part of the prior art.

### SUMMARY

Exemplary embodiments of the present invention provide a method of manufacturing strain insulators. Additional features of the invention will be set forth in the following description, and in part will be apparent from the description, or may be learned from practice of the invention.

An exemplary embodiment of the present invention discloses a method of manufacturing strain insulators including swaging, by a die-set, a sleeve of an end fitting on a portion of a core strength rod, the portion being disposed inside the sleeve of the end fitting. The swaging may be performed by an upper block and a lower block of the die-set. At least one of the upper and lower blocks may be movable such as to allow for compressing the sleeve of the end fitting on the rod disposed between the blocks. The upper block may include a plurality of protrusions extended lengthwise on the upper block and the lower block may include a plurality of protrusions extended lengthwise on the lower block.

Exemplary embodiments of the present invention also provide a method for manufacturing strain insulators wherein the upper block comprises a plurality of segments. The segments may be disposed parallel to each other such as to form substantially a cylindrical arc shape. Each extended protrusion may be disposed on an a segment of the plurality of segments such that the extended protrusions are facing an inner side of the cylindrical arc shape. A length of the extended protrusions may be substantially longer than the width and the height of the protrusions.

Exemplary embodiments of the present invention may further provide a method for manufacturing strain insulators for which the protrusions may be disposed on the upper block and lower block such that, upon compressing the sleeve of the end fitting on the rod, each protrusion forms a dent on the sleeve and compresses the sleeve on the rod over a line shaped compression area.

A mechanical stress point loading of the strain insulators manufactured according to the exemplary embodiments of the invention may be smaller than for the strain insulators manufactured by the conventional methods. As a result, a lifespan of the strain insulators manufactured by the methods according to the exemplary embodiments of the invention is expected to be improved.

Moreover, the design of the manufacturing process according to exemplary embodiments of the invention may allow for improved manufacturing efficiencies, improved portability and ease of use both in the factory setting and on the field.

However, achieving the above purposes and/or benefits is not a necessary feature to each of the exemplary embodiments and claims may recite subject matter that does not achieve the above stated purposes and/or benefits.

The foregoing general description and the following detailed description are only exemplary and explanatory and they are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a conventional strain insulator.

FIG. 2A is a schematic diagram showing a strain insulator during swaging and crimping manufacturing process.

FIG. 2B is a schematic diagram showing a cross-section along section 2B of the strain insulator in FIG. 2A.

FIG. 3A is a schematic diagram of a conventional die-set.

FIG. 3B is a schematic diagram of a strain insulator disposed in a conventional die-set during swaging and crimping.

FIG. 4A shows a perspective view of a die-set for swaging and crimping strain insulators according to an exemplary embodiment of the invention.

FIG. 4B shows front view of a die-set for swaging and crimping strain insulators according to an exemplary embodiment of the invention.

FIG. 5 shows a perspective view of a die-set and a strain insulator manufactured by the die-set according to a an exemplary embodiment of the invention.

FIGS. 6A and B show a first and a second perspective view of an upper compression block of the die-set for swaging and crimping strain insulators according to an exemplary embodiment of the invention.

FIG. 6C show a side view of an upper compression block of the die-set for swaging and crimping strain insulators according to an exemplary embodiment of the invention.

FIGS. 7A and B show a first and a second perspective view of an lower compression block of the die-set for swaging and crimping strain insulators according to an exemplary embodiment of the invention.

FIG. 7C shows a side view of a lower compression block of the die-set for swaging and crimping strain insulators according to an exemplary embodiment of the invention.

FIG. 8 shows a detailed view of an assembly formed by the upper block and the upper part according to an exemplary embodiment of the invention.

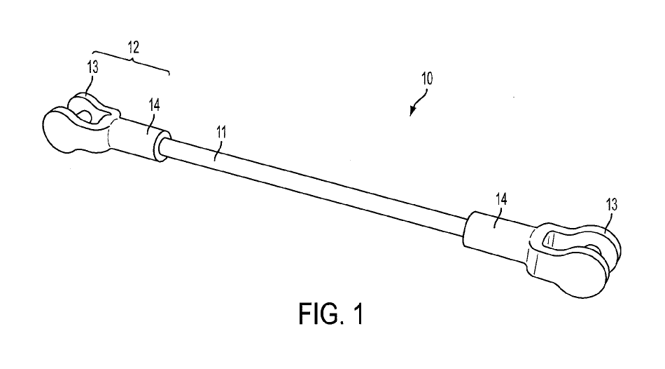

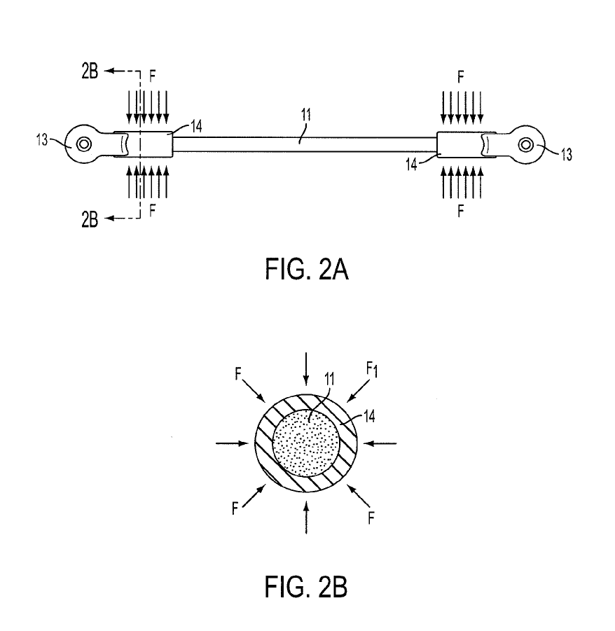

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The aspects of the invention in this application are not limited to the disclosed operations and sequence of operations. For instance, operations may be performed by various elements and components, may be consolidated, may be omitted, and may be altered without departing from the spirit and scope of the present invention.

It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The terminology used herein is for the purpose of describing particular embodiments only and is not intended to be limiting of the present disclosure.

Although some features may be described with respect to individual exemplary embodiments, aspects need not be limited thereto such that features from one or more exemplary embodiments may be combinable with other features from one or more exemplary embodiments.

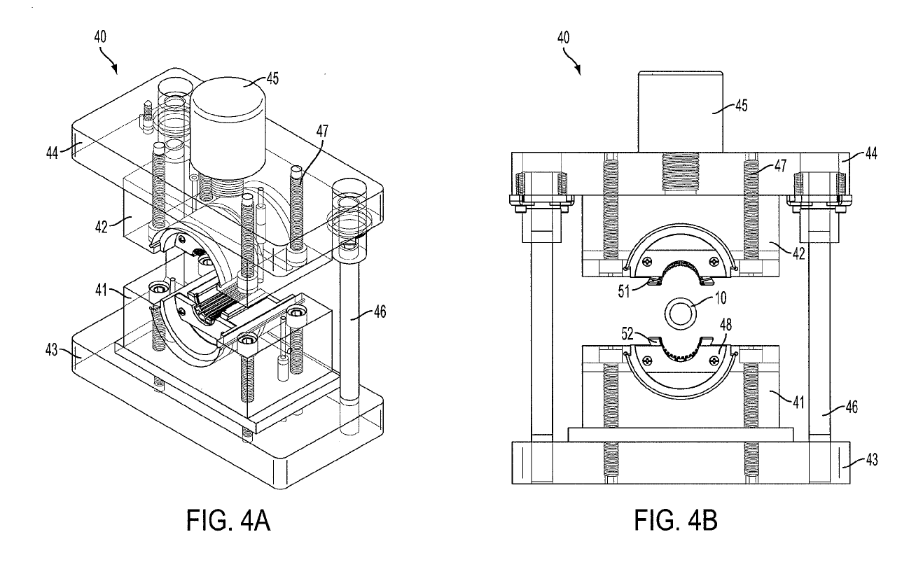

FIG. 4 show a die-set for manufacturing strain insulators according to an exemplary embodiment of the invention. FIGS. 4A and 4B show a perspective view and a front view, respectively, of the die-set. The die-set may include a lower part 41, an upper part 42, a lower base 43, an upper base 44, a pressure screw 45, one or more guide posts 46, and one or more set-screws 47. The lower part 41 may include a lower compression block 51. The upper part 42 may include an upper compression block 52.

The upper part 42 may be affixed to the upper base 44 by a plurality of screws 47. The lower part 41 may be affixed to the lower base 43 by a plurality of screws 47. The lower base may be disposed on the ground or on a bench such as to immobilize the die-set during manufacturing. The upper base 44 may move up and down vertically such as to allow for swaging and crimping of a fitting sleeve on a rod disposed inside the sleeve. The vertical movement of the upper base 44 may be guided by a set of guiding posts 46. A pressure screw 45 may be used to exert pressure on the upper part 41 and the upper block 51.

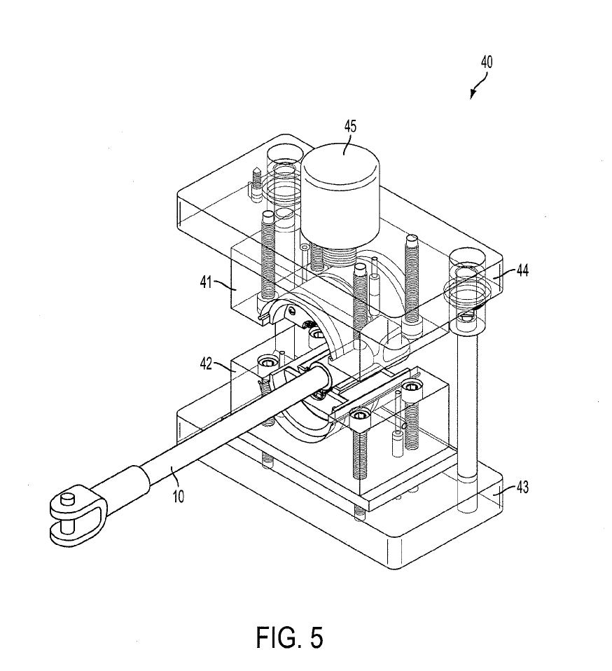

The fiberglass rod and an end fitting of a strain insulator 10 may be disposed between the blocks 51 and 52 as shown in FIG. 4B and FIG. 5. The screw 45 may move the upper block against the lower block such that the upper block 51 presses on an upper side of the sleeve of the insulator and the lower block 52 presses on the lower side of the sleeve thereby swaging and/or crimping the sleeve 14 of the end fitting on the fiber glass rod 11.

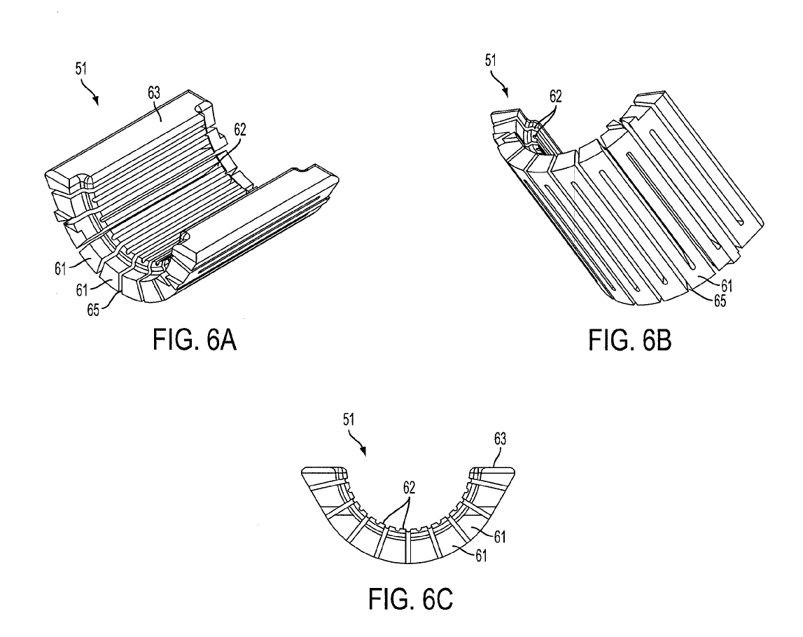

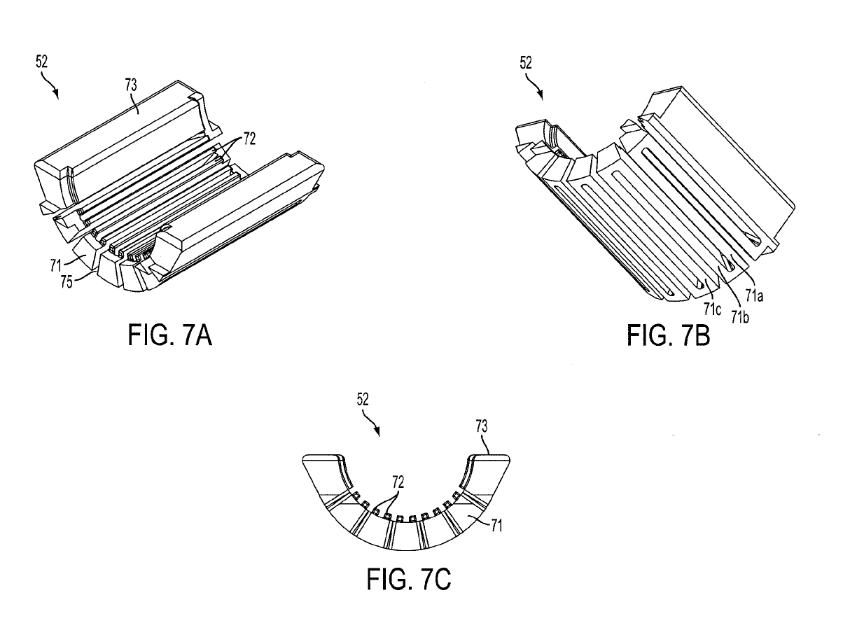

The upper block 51 may include a plurality of protrusions 62 disposed in between a plurality of grooves as shown in FIGS. 6A to 6C. The lower block 52 may include a plurality of protrusions 72 and grooves as shown in FIGS. 7A to 7C. The blocks 51 and 52 may be made of a material having significant strength such that the protrusions of the block can withstand significant pressure and can perform good quality crimping and swaging of the fittings sleeve on the fiberglass rod without sustaining damage.

FIGS. 6A and 6B show a first and a second perspective view of an upper block 51 of the die-set for swaging and crimping strain insulators according to an exemplary embodiment of the invention. A side view of the upper block 51 is shown by FIG. 6C. The upper block 51 includes a plurality of segments 61 spaced apart by a plurality of gaps 65. The segments may be disposed substantially parallel with each other such as to form approximately an arc portion of cylinder (e.g. a half cylinder). The segments may have a first side surface facing towards the inner side of the are portion of the cylinder, a second side surface facing towards an outside of the cylinder, and two side surfaces facing neighboring segments. The segments 61 may include a plurality of protrusions 62 disposed on the first side of the segments and facing towards the inner of the upper block 51.

FIGS. 7A and 7B show a first and a second perspective view of a lower block 52 of the die-set for swaging and crimping strain insulators according to an exemplary embodiment of the invention. A side view of the lower block 52 is shown by FIG. 7C. The upper block 52 includes a plurality of segments 71 spaced apart by a plurality of gaps 75. The segments may be disposed substantially parallel with each other such as to form approximately an arc portion of cylinder (e.g. a half cylinder). The segments may have a first side surface facing towards the inner side of the cylinder, a second side surface facing towards an outside of the cylinder, and two side surfaces facing neighboring segments. The segments 71 may include a plurality of protrusions 72 disposed on the first side of the segments and facing towards the inner of the lower block 52.

The side segments 73 may be larger than segments 71 and may not include protrusions. The segments 71 may be connected to each other in an “S” shape. For example, segment 71A may be connected with segment 71(b) via a first end of the segment 71(b), whereas segment 71(b) may be connected to segment 71(c) via a second end of the segment 71(b).

The protrusions 61 and 71 may extend on a length of the segments, as cylindrical surfaces. A length of the protrusions may be substantially larger than a width and a height of the protrusions. The protrusions may have rounded tops. A cross-section of the protrusions, by a plane perpendicular on the length of the segments, may have a semicircular shape, a round shape or other shapes.

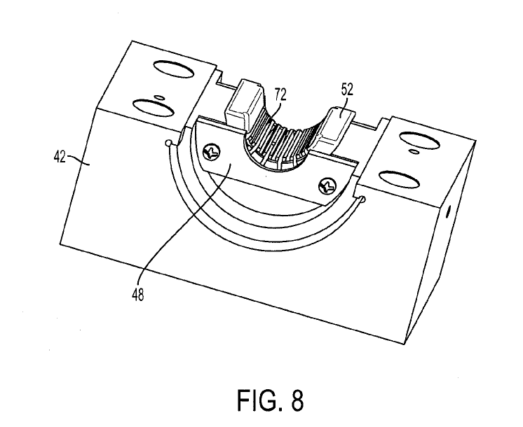

FIG. 8 shows a detailed view of an assembly formed by the upper block and the upper part according to an exemplary embodiment of the invention. The upper block 51 may be attached and fixed on the upper part 41 by a retainer 48 via one or more set screws or by other means. The upper block and the upper part may be built to be integrated as a single part or component. However, it is preferable that the upper block 51 is separate from the upper part 41.

Methods and processes for manufacturing strain insulators, according to exemplary embodiments of the invention, are described hereinafter with reference to the figures in the drawings. A first end of a fiberglass rod 11 may be inserted in the sleeve 14 of an end fitting 12. The assembly rod and end fitting may be disposed between the upper and lower blocks 51 and 52, as shown in FIG. 5, such that the blocks can crimp and/or swagger the sleeve 41 on the rod 10. The upper block 51 is moved downward such that the sleeve and the rod disposed inside the sleeve are caught between the blocks 51 and 52. The upper block 51 is pressed on the sleeve by such a force as to perform swaging and/or crimping of the sleeve on the rod.

The screw 45 may be used to move the upper block up and down vertically. Further, the screw 45 may be used to apply pressure on the upper block 51 thereby performing swaging and/or crimping. The vertical motion of the upper block may be restricted to the level at which side segments 63 of the upper block 51 may touch the side segments 73 of the lower block 52.

Upon pressing the upper. block 51 on the sleeve 14 the protrusions 61 and 71 of the blocks create dents on the sleeve material and push the sleeve towards the rod disposed inside the sleeve. The dents formed in the sleeve may push and deform the fiberglass rod material thereby forming a plurality of contact stress areas between the inside of the sleeve and the fiberglass rod. The deformation stress and/or tension generated between the sleeve dents and the fiberglass rod over the contact stress areas may mechanically affix the sleeve 14 to the fiberglass rod 11. The larger the stress and tension the stronger the mechanical bond formed between the sleeve 14 and the rod 11.

The dents formed on the sleeve and the contact stress areas may be line shaped since the protrusions 61 and 71 of the blocks are disposed lengthwise over the segments. A length of the stress area lines may be substantially longer than their width. As a result, upon performing swaging and/or crimping according to the method above, the contact stress areas formed between the inside of the sleeves and the core fiberglass rod may have a line shape, thereby distributing the contact stress on the core fiberglass rod over the line surface. Further, since the above method of swaging and/or crimping leads to forming a plurality of line stress areas, the total stress associated with swaging and/or crimping is further distributed or shared among the multiple contact lines corresponding to the multiple protrusions 61 and 71.

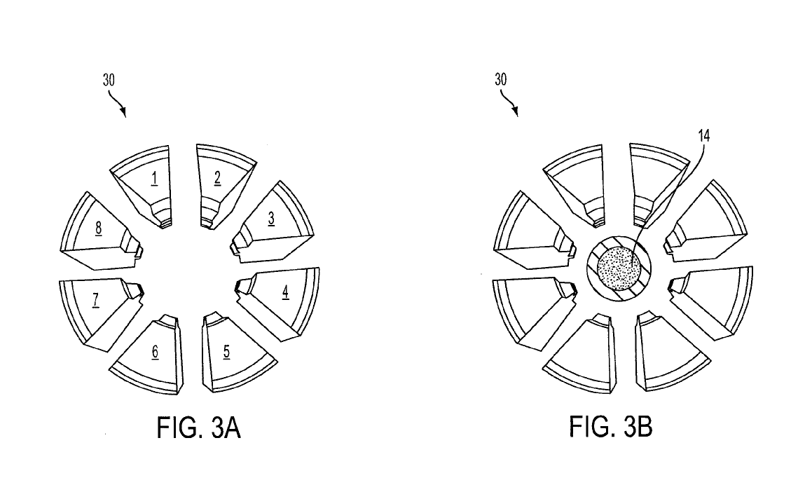

The advantages and benefits of the manufacturing methods according to the exemplary embodiments above in comparison to the conventional methods become apparent when comparing the mechanical stress loading caused by the crimping process on the core fiberglass rod. The mechanical stress loading of a strain insulator manufactured by the conventional method (e.g. by using the die-set shown in FIG. 3) is a mechanical stress point loading distributed over one or more small point contact areas. Consequently, the mechanical stress point loading may be quite large and may lead to the deterioration in time of the strain insulator.

In contrast, the mechanical stress loading of a strain insulator manufactured by the method according to the exemplary embodiments described above is distributed over the area of the contact stress lines. The area of the contact stress lines may be significantly larger than the area of the contact point areas of the strain insulators manufactured by the conventional methods. Thus, the mechanical stress point loading of the strain insulators manufactured according to the exemplary embodiments above (e.g. by using the die-set in FIGS. 4 and 5) may be significantly smaller than for the strain insulators manufactured by the conventional methods. As a result, a lifespan of the strain insulators manufactured by using the die-set in FIGS. 4-5 is expected to increase.

Moreover, the design of the manufacturing process according to exemplary embodiments of the invention, such as by using the die-set shown in FIGS. 4-8, allows for improved manufacturing efficiencies, improved portability and ease of use both in the factory setting and on the field.

While the exemplary embodiments have been shown and described, it will be understood by those skilled in the art that various changes in form and details may be made thereto without departing from the spirit and scope of the present disclosure as defined by the appended claims.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of manufacturing strain insulators, the method comprising:
swaging, by a die-set, a sleeve of an end fitting on a portion of a core strength rod, the portion being disposed inside the sleeve of the end fitting;
wherein the swaging is performed by an upper block and a lower block of the die-set,
wherein at least one of the upper block and the lower block are movable such as to allow for compressing the sleeve of the end fitting on the rod disposed between the blocks;
wherein the upper block comprises a plurality of protrusions extended over a length of the upper block; and
wherein the lower block comprises a plurality of protrusions extended over a length of the lower block.

2. The method of manufacturing strain insulators of claim 1, wherein a length of the protrusions is substantially longer than the width and the height of the protrusions.

3. The method of manufacturing strain insulators of claim 1, wherein the upper block comprises a plurality of segments, the segments being disposed parallel to each other such as to form substantially a cylindrical arc shape.

4. The method of manufacturing strain insulators of claim 3, wherein each protrusion is disposed on a segment of the plurality of segments such that the protrusions are facing an inner side of the cylindrical arc shape.

5. The method of manufacturing strain insulators of claim 1, wherein the protrusions are disposed on the upper block and lower block such that, upon compressing the sleeve of the end fitting on the rod, each protrusion forms a dent on the sleeve and compresses the sleeve on the rod over a line shaped compression area.

6. The method of manufacturing strain insulators of claim 1, wherein upon swaging the sleeve of the end fitting on the portion of the core strength rod, a plurality of contact stress areas are formed between the inside of the sleeves and the core strength rod.

7. The method of manufacturing strain insulators of claim 6, wherein each contact stress area corresponds to one protrusion of the plurality of protrusions.

8. The method of manufacturing strain insulators of claim 6, wherein each of the contact stress areas has substantially a line shape.

9. The method of manufacturing strain insulators of claim 6, wherein the contact stress, due to swaging the end fitting on the core strength rod, is distributed over the plurality of contact stress areas.

10. The method of manufacturing strain insulators of claim 1, wherein the swaging is performed only by the upper block and the lower block of the die-set.
